(19) United States
(12) Patent Application Publication
(10) Pub. No.: US 2023/0083788 A1
(43) Pub. Date: Mar. 16, 2023

(54) COMPUTING DEVICE AND COMPUTING METHOD

(71) Applicants: Mitsubishi Electric Corporation, Tokyo (JP); MITSUBISHI ELECTRIC RESEARCH LABORATORIES, INC., Cambridge, MA (US)

(72) Inventors: Junya HATTORI, Tokyo (JP); Masaya Endo, Tokyo (JP); Yuko Omagari, Tokyo (JP); Tomoki Uno, Tokyo (JP); Stefano Di Cairano, Cambridge, MA (US); Rien Quirynen, Cambridge, MA (US)

(73) Assignees: Mitsubishi Electric Corporation, Tokyo (JP); MITSUBISHI ELECTRIC RESEARCH LABORATORIES, INC., Cambridge, MA (US)

(21) Appl. No.: 17/473,505

(22) Filed: Sep. 13, 2021

(51) Int. Cl. G06F 17/18; G06F 17/16

(52) U.S. Cl. CPC G06F 17/18; G06F 17/16

(57) ABSTRACT

A processor of a computing device comprises: a generation unit to generate an active constraint set based on an inequality constraint set and an initial solution; a search unit to find a solution of a simultaneous linear equation generated based on the active constraint set and an evaluation function; and an updating unit to update the active constraint set based on the solution obtained by the search unit. The generation unit adds, to the active constraint set, the first inequality constraint determined as being not linearly dependent on one or more second inequality constraints included in the active constraint set.

### BACKGROUND OF THE INVENTION

### Field of the Invention

The present disclosure relates to a computing device and a computing method.

### Description of the Background Art

Conventionally, in a convex quadratic programming problem, model predictive control has been known in which an optimal control quantity is determined by using a predictive model to predict a state quantity of a control target during a period from a current state to a time that represents a near future (for example, Japanese Patent Laying-Open No. 2016-10009). The model predictive control employs an evaluation function generated based on a difference between the state quantity of the control target and a target value of the state quantity and a difference between the control quantity and a target value of the control quantity, and computation is performed to determine a control quantity that minimizes the evaluation function in consideration of an active constraint for the control quantity.

### SUMMARY OF THE INVENTION

In a conventional computing device for finding an optimal solution of a convex quadratic programming problem, when a plurality of inequality constraints that are set as active constraints are not in a linearly independent relation, the dimensions of a simultaneous linear equation including a condition to be satisfied by the optimal solution are decreased. When the dimensions of the simultaneous linear equation are decreased, the computing device cannot find the optimal solution. Further, in order to confirm that the plurality of inequality constraints that are set as the active constraints are not in a linearly independent relation, the computing device needs to compute the rank of a matrix in each inequality constraint, with the result that a computation load may become large.

The present disclosure has been made in view of the above-described problem, and has an object to provide a computing device and a computing method, by each of which an optimal solution of a convex quadratic programming problem can be found while avoiding a large computation load as much as possible.

A computing device according to the present disclosure is an device for finding an optimal solution of a convex quadratic programming problem. The computing device comprises: an interface to obtain an evaluation function, an inequality constraint set, and an initial solution of the convex quadratic programming problem; and a processor to find the optimal solution based on the evaluation function, the inequality constraint set, and the initial solution obtained by the interface. The processor includes a generation unit, a search unit, and an updating unit. The generation unit generates an active constraint set based on the inequality constraint set and the initial solution. The search unit finds a solution of a simultaneous linear equation generated based on the active constraint set and the evaluation function. The updating unit updates the active constraint set based on the solution obtained by the search unit. The generation unit comprises an addition determination unit, a linear dependence determination unit, and an active constraint addition unit. The addition determination unit determines whether or not the inequality constraint set includes a first inequality constraint that satisfies a condition for addition to the active constraint set. The linear dependence determination unit determines whether or not the first inequality constraint that satisfies the condition is linearly dependent on one or more second inequality constraints included in the active constraint set. The active constraint addition unit adds, to the active constraint set, the first inequality constraint determined by the linear dependence determination unit as being not linearly dependent on the one or more second inequality constraints.

A computing method according to the present disclosure is a method for finding an optimal solution of a convex quadratic programming problem by a computer. The computing method includes: (a) generating an active constraint set based on an inequality constraint set and an initial solution in the convex quadratic programming problem; (b) finding a solution of a simultaneous linear equation generated based on the active constraint set and an evaluation function in the convex quadratic programming problem; and (c) updating the active constraint set based on the solution obtained by the finding of the solution. The generating (a) comprises: (a1) determining whether or not the inequality constraint set includes a first inequality constraint that satisfies a condition for addition to the active constraint set; (a2) determining whether or not the first inequality constraint that satisfies the condition is linearly dependent on one or more second inequality constraints included in the active constraint set; and (a3) adding, to the active constraint set, the first inequality constraint determined, by the determining of whether or not the first inequality constraint that satisfies the condition is linearly dependent on the one or more second inequality constraints included in the active constraint set, as being not linearly dependent on the one or more second inequality constraints.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a hardware configuration of a computing device according to an embodiment.

FIG. 2 is a diagram showing a coefficient matrix of a linear constraint.

FIG. 3 is a diagram showing a functional configuration of the computing device according to the embodiment.

FIG. 4 is a diagram showing a functional configuration of a generation unit according to the embodiment.

FIG. 5 is a diagram showing exemplary linear dependence determination.

FIG. 6 is a diagram showing exemplary linear dependence determination.

FIG. 7 is a diagram showing exemplary linear dependence determination.

FIG. 8 is a flowchart showing a computation process of the computing device according to the embodiment.

FIG. 9 is a flowchart showing a generation process of the computing device according to the embodiment.

FIG. 10 is a flowchart showing a search process of the computing device according to the embodiment.

FIG. 11 is a flowchart showing an updating process of the computing device according to the embodiment.

### DESCRIPTION OF THE PREFERRED EMBODIMENTS

Hereinafter, an embodiment will be described with reference to figures. It should be noted that in the figures, the same or corresponding portions are denoted by the same reference characters, and will not be described repeatedly.

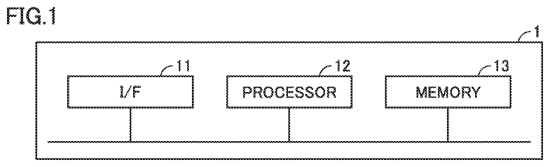

FIG. 1 is a diagram showing a hardware configuration of a computing device 1 according to an embodiment. Computing device 1 according to the embodiment is realized by a control unit mounted on a device that needs to solve an optimization problem. For example, when computing device 1 is implemented in a control unit mounted on a vehicle, computing device 1 can solve an optimization problem for causing the vehicle to follow a target route, or can solve an optimization problem for optimizing fuel consumption. When computing device 1 is implemented in a factory control device, computing device 1 can solve an optimization problem for optimizing an operation of the factory.

As shown in FIG. 1, computing device 1 includes an interface (I/F) 11, a processor 12, and a memory 13.

Interface 11 obtains various types of optimization problems such as a convex quadratic programming problem. Further, interface 11 outputs, to a control target or the like, a result of computation of the optimization problem by processor 12.

Processor 12 is an example of a “computer”. Processor 12 is constituted of a CPU (Central Process Unit), an FPGA (Field Programmable Gate Array), or the like, for example. Processor 12 may be constituted of a processing circuitry such as an ASIC (Application Specific Integrated Circuit). Processor 12 finds an optimal solution by computing an optimization problem.

Memory 13 is constituted of a volatile memory such as a DRAM (Dynamic Random Access Memory) or an SRAM (Static Random Access Memory), or is constituted of a nonvolatile memory such as a ROM (Read Only Memory). Memory 13 may be a storage device including an SSD (Solid State Drive), an HDD (Hard Disk Drive), and the like. Memory 13 stores a program, computation data, and the like for processor 12 to solve an optimization problem.

Computing device 1 may be any device as long as computing device 1 is a device for finding an optimal solution of a convex quadratic programming problem, and an optimization problem serving as the object of computation by computing device 1 is not particularly limited. In the embodiment, a convex quadratic programming problem for model predictive control is illustrated as the optimization problem serving as the object of computation by computing device 1.

The model predictive control is a method for determining an optimal control quantity by using a predictive model f to predict a state quantity of a control target during a period from a current state to a time T that represents a near future. The model predictive control is represented by the following formulas (1) and (2):

$${min}_{x , u} {\int }_{0}^{T} l ( x ( t ) , u ( t ) ) dt \qquad ( 1 )$$

$$\begin{matrix}s . t . f ( x ( t ) , \dot{x} ( t ) , u ( t ) ) = 0 , \\ p ( x ( t ) , u ( t ) ) \leq 0\end{matrix} \qquad ( 2 )$$

In the formulas (1) and (2), x represents a state variable and u represents a control variable. In the model predictive control, the value of the control variable for minimizing an evaluation function 1 is found, evaluation function 1 being generated based on a difference between state variable x and a target value of state variable x, a difference between control variable u and a target value of control variable u, and the like.

It should be noted that in the case of handling an optimization problem for finding the value of the control variable for maximizing evaluation function 1, the optimization problem can be handled as the optimization problem for finding the value of the control variable for minimizing evaluation function 1 by multiplying evaluation function 1 by “−1” to invert the sign of evaluation function 1.

Further, the optimization problem according to the embodiment includes an upper limit constraint as represented by the formula (2), but may include a lower limit constraint. For example, in the case of handling the lower limit constraint, the lower limit constraint can be handled as the upper limit constraint as represented by the formula (2), by multiplying both sides of the lower limit constraint by “−1” to invert the sign of the lower limit constraint.

In the description below, it is assumed that computing device 1 finds an optimal solution with regard to model predictive control involving control variable u including at least one slack variable for relieving a constraint.

When discretization is performed onto the formulas (1) and (2) at each prediction time t=nΔt (n=0, 1, 2, . . . , N) and linearization is performed onto the formulas (1) and (2) using initial state quantity and initial control quantity at each prediction time, a convex quadratic programming problem represented by formulas (3) to (5) is obtained.

$${min}_{Δ {x}_{n} , Δ {u}_{n}} {\sum }_{n = 0}^{N} {\frac{1}{2} [ \begin{matrix}Δ {x}_{n} \\ Δ {u}_{n}\end{matrix} ]}^{T} {Q}_{n} [ \begin{matrix}Δ {x}_{n} \\ Δ {u}_{n}\end{matrix} ] + {q}_{n}^{T} [ \begin{matrix}Δ {x}_{n} \\ Δ {u}_{n}\end{matrix} ] \qquad ( 3 )$$

$$Δ {x}_{n + 1} = {a}_{n} + [ \begin{matrix}{F}_{n} & {G}_{n}\end{matrix} ] [ \begin{matrix}Δ {x}_{n} \\ Δ {u}_{n}\end{matrix} ] \qquad ( 4 )$$

$$p ( Δ {x}_{n} , Δ {u}_{n} ) \leq {p}_{n} \qquad ( 5 )$$

In the formulas (3) to (5), T=NΔt. Δx represents a difference between the state variable and the initial state quantity. Δu represents a difference between the control variable and the initial control quantity. Qₙ and qₙ represent coefficients when the discretization and the linearization are performed onto the evaluation function. aₙ represents a constant term when the discretization and the linearization are performed onto the predictive control model. Fₙ represents a coefficient of the state variable when the discretization and the linearization are performed onto the predictive control model. Gₙ represents a coefficient of the control variable when the discretization and the linearization are performed onto the predictive control model.

Regarding the order of performing the discretization and the linearization, the discretization may be performed first and then the linearization may be performed, or the linearization may be performed first and then the discretization may be performed. Alternatively, the discretization and the linearization may be performed in parallel.

When current state quantity xo is regarded as a constant term and state variable xₙ with n=0, 1, 2, . . . , N is eliminated using the recurrence formula of the formula (4), a convex quadratic programming problem using only control variable u as represented by formulas (6) and (7) is obtained.

$${min}_{Δ u} \frac{1}{2} Δ {u}^{T} \overline{Q} Δ u + {\overline{q}}^{T} Δ u \qquad ( 6 )$$

$$s . t . D Δ u \leq \overline{p} \qquad ( 7 )$$

Further, when the evaluation function of the convex quadratic programming problem as represented by the formula (6) is represented by a below-described formula (8) and the inequality constraint of the convex quadratic programming problem as represented by the formula (7) is represented by a below-described formula (9), a convex quadratic programming problem to be optimized by computing device 1 according to the embodiment is obtained.

$${min}_{w} J = \frac{1}{2} {w}^{T} H w + {h}^{T} w \qquad ( 8 )$$

$$s . t . Cw \leq v \qquad ( 9 )$$

In the formulas (8) and (9), J represents the evaluation function of the convex quadratic programming problem, w represents a solution vector, w^{T} represents a transposed solution vector, H represents a Hessian matrix, h^{T} represents an adjustment row vector, C represents a coefficient matrix of a linear constraint, and v represents a constraint vector.

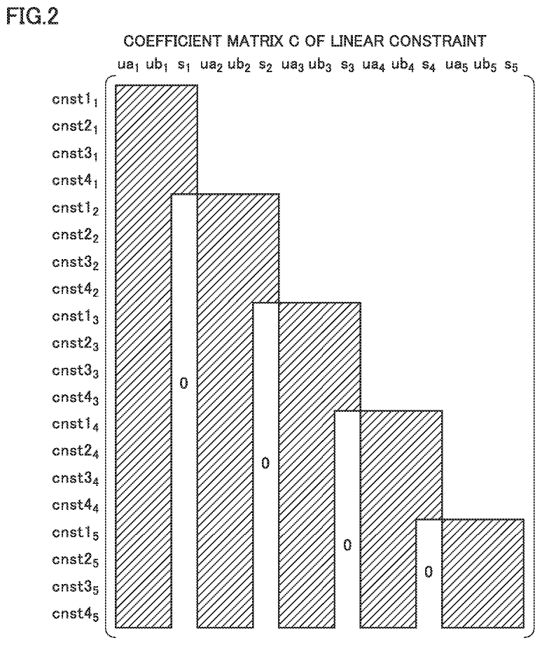

FIG. 2 is a diagram showing coefficient matrix C of the linear constraint. As shown in FIG. 2, coefficient matrix C is an m×n matrix. m=the number of inequality constraints p×number N of the prediction time steps. Coefficient matrix C is set such that constraints corresponding to prediction time steps n=1, 2, . . . , N appear from an upper row by the number of inequality constraints p. Since each inequality constraint is represented by a linear combination of control variables up to a corresponding prediction time step, non-zero elements of coefficient matrix C are limited to elements up to the (the number of control variables×prediction time step n)-th element. In the description below, for the sake of explanation, constraint numbers 1, 2, . . . are provided to respective inequality constraints in order from the upper row.

When the control variables include a slack variable, the inequality constraint for prediction time step n is represented by a linear combination of the control variables other than the slack variable and up to prediction time step n and the slack variable for prediction time step n, so that slack variable coefficients up to the prediction time step (n−1) are 0.

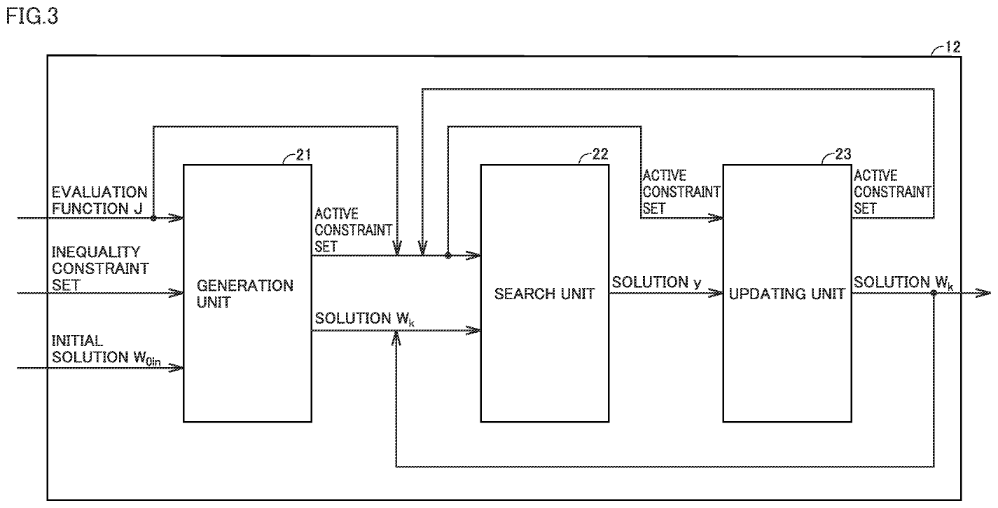

FIG. 3 is a diagram showing a functional configuration of computing device 1 according to the embodiment. In the description below, it will be illustratively described that computing device 1 uses a primal active set method as the method for finding the optimal solution of the convex quadratic programming problem; however, computing device 1 may find the optimal solution using another method.

As shown in FIG. 3, as main functions, computing device 1 includes a generation unit 21, a search unit 22, and an updating unit 23. Each of the functional units included in computing device 1 is implemented by executing, by processor 12, a program stored in memory 13. It should be noted that each of the functional units included in computing device 1 may be implemented by cooperation of a plurality of processors 12 and a plurality of memories 13.

First, via interface 11, computing device 1 obtains: evaluation function J, which is represented by the formula (8), of the convex quadratic programming problem; an inequality constraint set of the convex quadratic programming problem, the inequality constraint set serving as the linear constraint and being represented by the formula (9); and an initial solution w₀ᵢₙ of the convex quadratic programming problem.

Generation unit 21 generates an active constraint set and a feasible initial solution w₀ based on the inequality constraint set and initial solution won, obtained by interface 11.

Search unit 22 obtains evaluation function J of the optimization problem, the active constraint set generated by generation unit 21, and solution wₖ. Search unit 22 generates a simultaneous linear equation for finding the optimal solution of the convex quadratic programming problem, based on the obtained active constraint set and evaluation function J. Specifically, search unit 22 generates a simultaneous linear equation for solving the minimization problem of evaluation function J having only active constraints as constraints. Search unit 22 finds solution y of the simultaneous linear equation.

Updating unit 23 obtains the active constraint set generated by generation unit 21 and solution y obtained by search unit 22. Updating unit 23 updates the active constraint set and the solution based on solution y obtained by search unit 22, and outputs the active constraint set and optimal solution wₖ.

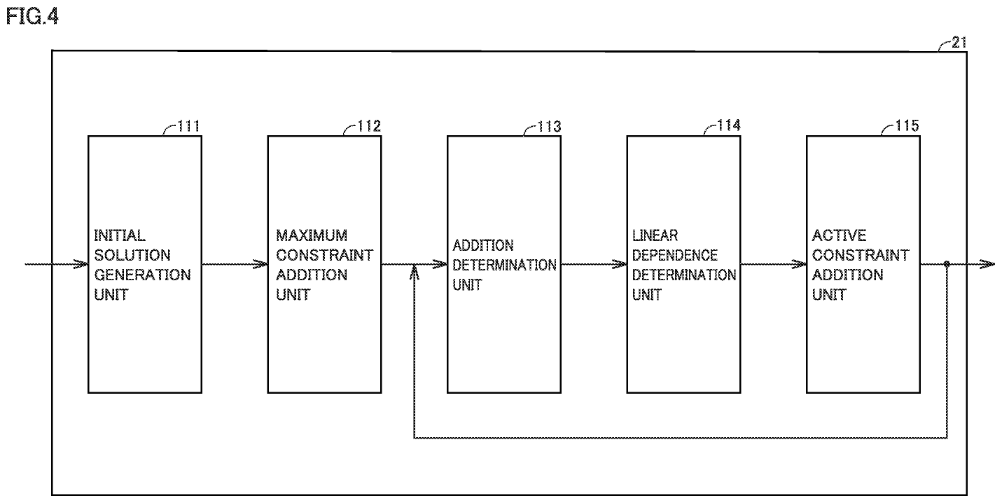

The following specifically describes generation unit 21 with reference to FIG. 4. FIG. 4 is a diagram showing a functional configuration of generation unit 21 according to the embodiment. As shown in FIG. 4, generation unit 21 includes an initial solution generation unit 111, a maximum constraint addition unit 112, an addition determination unit 113, a linear dependence determination unit 114, and an active constraint addition unit 115.

When initial solution w₀ᵢₙ satisfies the inequality constraint set represented by the formula (9), initial solution generation unit 111 regards initial solution w₀ᵢₙ as feasible initial solution w₀. When initial solution w₀ᵢₙ does not satisfy the inequality constraint set and initial solution w₀ᵢₙ is an unfeasible solution, initial solution generation unit 111 uses the following formula (10) to generate a feasible initial solution w₀ that satisfies the inequality constraint set.

$${w}_{s [ i ]} = {s}_{n} = {s}_{n} - \frac{{\sum }_{j} {C}_{i j} \overline{{w}_{j}} - v}{{C}_{i , s [ i ]}} \qquad ( 10 )$$

In the formula (10), the subscript “s_{[i]}” represents an element number in solution w of a slack variable sₙ (≥0) corresponding to the inequality constraint. Initial solution generation unit 111 updates slack variable sₙ to have a larger value in the formula (10), thereby generating a feasible initial solution w₀ that satisfies the inequality constraint set in the formula (9).

Maximum constraint addition unit 112 regards, as an inequality constraint (hereinafter, also referred to as “third inequality constraint”) that is deviated the most from a constraint value at each prediction time, the inequality constraint updated to have the maximum slack variable value in the inequality constraint set. Maximum constraint addition unit 112 adds the third inequality constraint to the active constraint set in precedence over other inequality constraint. Thus, computing device 1 can add the third inequality constraint that is deviated most from the constraint value, to the active constraint set in precedence over inequality constraints added to the active constraint set after below-described processes performed by addition determination unit 113, linear dependence determination unit 114, and active constraint addition unit 115.

In the inequality constraint set, the inequality constraints other than the third inequality constraint are subjected to the processes by addition determination unit 113, linear dependence determination unit 114, and active constraint addition unit 115, in order of the constraint numbers.

Addition determination unit 113 determines whether or not the inequality constraint set has an inequality constraint (hereinafter, also referred to as “first inequality constraint”) that satisfies a condition for addition to the active constraint set. Specifically, addition determination unit 113 uses the following formula (11) to determine whether or not each inequality constraint satisfies a condition that allows the inequality constraint to be an active constraint in feasible initial solution w₀. In the formula (11), tol represents a determination threshold and has a small positive value.

$$\vert {v}_{i} - {\sum }_{j} {C}_{ij} {w}_{j} \vert < tol \qquad ( 11 )$$

In the inequality constraint set, the first inequality constraint that satisfies the condition of the formula (11) is a candidate to be added to the active constraint set.

Linear dependence determination unit 114 determines whether or not the first inequality constraint determined by addition determination unit 113 as satisfying the condition of the formula (11) is linearly dependent on one or more inequality constraints (hereinafter, also referred to as “second inequality constraints”) included in the active constraint set. That is, linear dependence determination unit 114 determines whether or not the first inequality constraint serving as the candidate to be added to the active constraint set is linearly dependent on the one or more second inequality constraints that are set as the current active constraints.

Specifically, in coefficient matrix C of the linear constraint, linear dependence determination unit 114 specifies a set (hereinafter, also referred to as “first set”) of one or more elements (control variables) having non-zero coefficients and included in the first inequality constraint that satisfies the condition for addition to the active constraint set. Further, linear dependence determination unit 114 specifies a set (hereinafter, also referred to as “second set”) of one or more elements (control variables) having non-zero coefficients and included in each of the one or more second inequality constraints that are set as the current active constraints. Linear dependence determination unit 114 determines that the first inequality constraint is linearly dependent on the one or more second inequality constraints, when the second set is a subset of the first set and the number of the one or more elements included in each of the one or more second inequality constraints and having the non-zero coefficients is more than or equal to the number of the one or more elements included in the first inequality constraint and having the non-zero coefficients.

Active constraint addition unit 115 adds, to the active constraint set, the first inequality constraint determined by linear dependence determination unit 114 as being not linearly dependent on the one or more second inequality constraints. Thus, computing device 1 can maintain, in a linearly independent relation, the plurality of inequality constraints that are set as active constraints.

As shown in FIG. 2, in coefficient matrix C of the inequality constraint generated in the model predictive control, control variables having non-zero coefficients exist up to prediction times corresponding to the respective constraints. In other words, when the inequality constraints are arranged in the order of the prediction times, the number of control variables having non-zero coefficients is larger in latter constraints. When determining whether or not the first inequality constraint is linearly dependent on the one or more second inequality constraints, linear dependence determination unit 114 does not necessarily need to specifically find each of the first set and the second set. By utilizing such a feature that the non-zero elements of coefficient matrix C exist only in the elements corresponding to the control variables prior to the prediction times corresponding to the respective inequality constraints, linear dependence determination unit 114 can determine whether or not there is a linear dependence using a linear dependence flag in the following manner.

Specifically, in order of one or more constraint numbers of the one or more second inequality constraints that are set as the current active constraints, linear dependence determination unit 114 establishes one or more linear dependence flags for one or more elements which have non-zero coefficients and for which no linear dependence flags have been established. Linear dependence determination unit 114 determines whether or not the one or more linear dependence flags are established for all of the one or more elements included in the first inequality constraint and having the non-zero coefficients. Here, when the one or more linear dependence flags are established, the number of the one or more second inequality constraints that satisfy such a condition that the second set is a subset of the first set is equal to the number of the dimensions of the first inequality constraint. In such a case, linear dependence determination unit 114 can determine that the first inequality constraint is linearly dependent on the second inequality constraint.

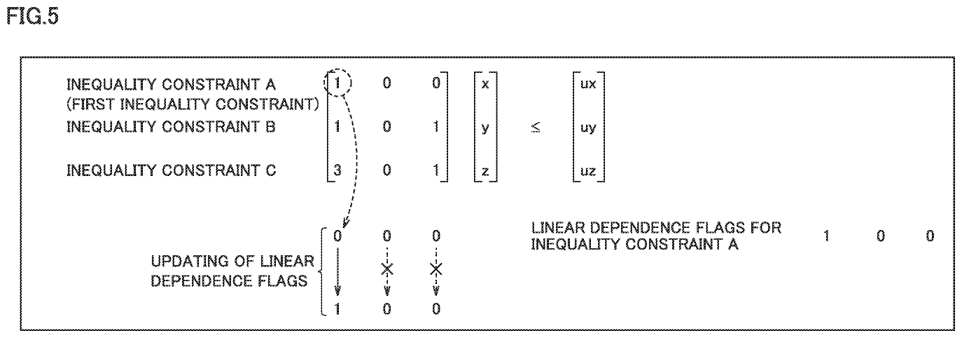

The following describes exemplary linear dependence determination with reference to FIGS. 5 to 7. FIGS. 5 to 7 are diagrams showing the exemplary linear dependence determination. Each of FIGS. 5 to 7 assumes such an example that coefficient matrix C of the linear constraint includes an inequality constraint A, an inequality constraint B, and an inequality constraint C.

As shown in FIG. 5, when determining whether to add inequality constraint A to the active constraint set as the “first inequality constraint”, in order of one or more constraint numbers of the one or more second inequality constraints that are set as the current active constraints, computing device 1 establishes one or more linear dependence flags for one or more elements which have non-zero coefficients and for which no linear dependence flags have been established. However, there is no inequality constraint corresponding to a constraint number smaller than the constraint number of inequality constraint A. That is, since no second inequality constraint that is set as an active constraint exists prior to inequality constraint A, computing device 1 sets inequality constraint A as an active constraint.

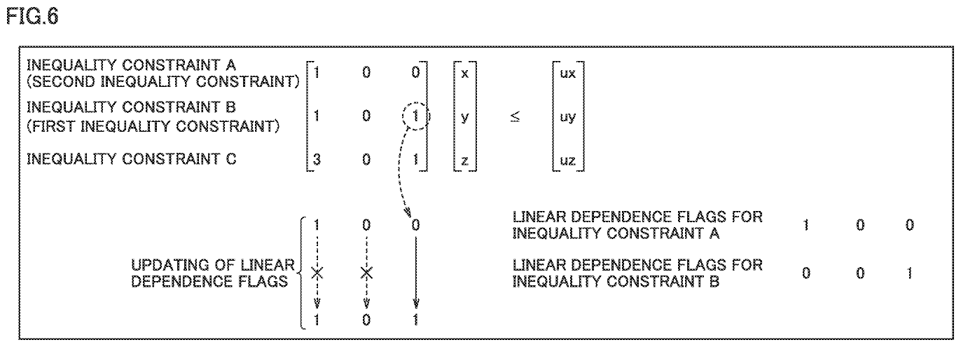

As shown in FIG. 6, when determining whether to add inequality constraint B to the active constraint set as the “first inequality constraint”, in order of one or more constraint numbers of the one or more second inequality constraints that are set as the current active constraints, computing device 1 establishes one or more linear dependence flags for one or more elements which have non-zero coefficients and for which no linear dependence flags have been established. Since only inequality constraint A is the second inequality constraint that is set as the current active constraint, computing device 1 establishes a linear dependence flag for an element having a non-zero coefficient in inequality constraint A.

In inequality constraint A, an element having a coefficient corresponding to x is “1”, an element having a coefficient corresponding to y is “0”, and an element having a coefficient corresponding to z is “0”. That is, inequality constraint A includes the element “1” corresponding to x as the “second set”. As shown in FIG. 5, computing device 1 sets a linear dependence flag for the element “1” corresponding to x in inequality constraint A.

In inequality constraint B, the element of the coefficient corresponding to x is “1”, the element of the coefficient corresponding to y is “0”, and the element of the coefficient corresponding to z is “1”. That is, inequality constraint B includes the element “1” corresponding to x and the element “1” corresponding to z as the “first set”.

Computing device 1 determines that the first inequality constraint (inequality constraint B) is not linearly dependent on the second inequality constraint (inequality constraint A), i.e., is linearly independent therefrom, because the second set is not a subset of the first set and the number (1 in this example) of the one or more elements included in the second inequality constraint (inequality constraint A) and having non-zero coefficients is not more than or equal to the number (2 in this example) of the one or more elements included in the first inequality constraint (inequality constraint B) and having non-zero coefficients. Therefore, computing device 1 adds inequality constraint B to the active constraint set.

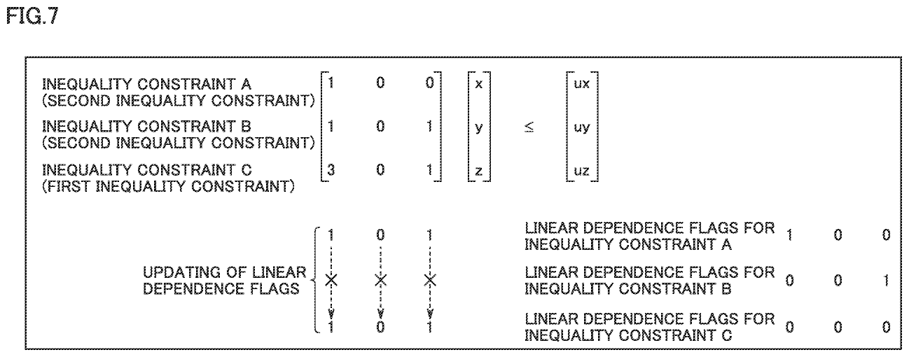

As shown in FIG. 7, when determining whether to add inequality constraint C to the active constraint set as the “first inequality constraint”, in order of one or more constraint numbers of the one or more second inequality constraints that are set as the current active constraints, computing device 1 establishes one or more linear dependence flags for one or more elements which have non-zero coefficients and for which no linear dependence flags have been established. Since inequality constraint A and inequality constraint B are the second inequality constraints that are set as the current active constraints, computing device 1 first establishes one or more linear dependence flags for the one or more elements having the non-zero coefficients in inequality constraint A as shown in FIG. 5. Next, in inequality constraint B, computing device 1 establishes one or more linear dependence flags for the one or more elements which have the non-zero coefficients and for which no linear dependence flags have been established, as shown in FIG. 6.

Inequality constraint A includes an element “1” corresponding to x. As shown in FIG. 5, computing device 1 establishes a linear dependence flag for the element “1” corresponding to x in inequality constraint A.

Inequality constraint B includes an element “1” corresponding to x and an element “1” corresponding to z. For the element “1” corresponding to x, the linear dependence flag has already been established in inequality constraint A, so that computing device 1 establishes a linear dependence flag only for the element “1” corresponding to z in inequality constraint B as shown in FIG. 6. Therefore, the set (second set) of the one or more elements having the non-zero coefficients and included in the second inequality constraints (inequality constraints A and B) that are set as the active constraints includes the element corresponding to x and the element corresponding to z.

In inequality constraint C, an element having a coefficient corresponding to x is “3”, an element having a coefficient corresponding to y is “0”, and an element having a coefficient corresponding to z is “1”. That is, inequality constraint C includes the element “3” corresponding to x and the element “1” corresponding to z as the “first set”. Computing device 1 determines that the first inequality constraint (inequality constraint C) is linearly dependent on the second inequality constraints (inequality constraints A and B), because the second set is a subset of the first set and the number (2 in this example) of the one or more elements included in each of the second inequality constraints (inequality constraints A and B) and having non-zero coefficients is more than or equal to the number (2 in this example) of the one or more elements included in the first inequality constraint (inequality constraint C) and having non-zero coefficients. Therefore, computing device 1 does not add inequality constraint C to the active constraint set.

By using the linear dependence flags in this way, computing device 1 can determine whether or not the first inequality constraint that satisfies the condition that allows the first inequality constraint to be the active constraint represented by the formula (11) is linearly dependent on the one or more second inequality constraints that are set as the active constraints.

As shown in FIG. 2, a prediction time corresponding to an inequality constraint with a smaller constraint number is closer to the present time, and such an inequality constraint has a smaller number of non-zero elements. Therefore, computing device 1 can readily find an element for which no linear dependence flag has been established yet, by determining whether or not there is a linear dependence in the order of the one or more constraint numbers, i.e., in the order from the inequality constraint with the smallest number of non-zero elements.

Generally, when determining whether or not the first inequality constraint is linearly dependent on the one or more second inequality constraints that are set as the active constraints, it is necessary to use a numeric computing method such as singular value decomposition. However, since such a numeric computing method may result in a large computation load, it is difficult to apply the numeric computing method to the model predictive control involving a short computation cycle in which control variables must be determined in real time.

Regarding this point, by utilizing such a feature that the non-zero elements of coefficient matrix C exist only in the elements corresponding to the control variables prior to the prediction times corresponding to the respective inequality constraints, computing device 1 according to the embodiment establishes a linear dependence flag in accordance with whether or not the coefficient is 0 in each of the first and second inequality constraints. By performing the linear dependence determination using such linear dependence flags, computing device 1 can find the optimal solution of the convex quadratic programming problem while avoiding a large computation load as much as possible.

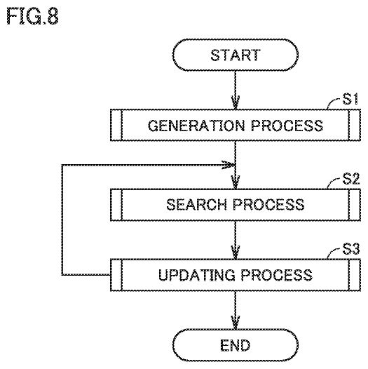

FIG. 8 is a flowchart showing a computation process of the computing device according to the embodiment. The computation process of computing device 1 is implemented by executing, by processor 12, a program stored in memory 13. It should be noted that the computation process of computing device 1 may be implemented by cooperation of a plurality of processors 12 and a plurality of memories 13.

As shown in FIG. 8, computing device 1 performs a generation process (S1). The generation process corresponds to the process performed by generation unit 21 in FIG. 2. By performing the generation process, computing device 1 generates an active constraint set and a feasible initial solution w₀ based on the inequality constraint set and initial solution worn obtained by interface 11.

Computing device 1 performs a search process (S2). The search process corresponds to the process performed by search unit 22 in FIG. 2. By performing the search process, computing device 1 generates a simultaneous linear equation for finding the optimal solution of the convex quadratic planning problem, based on the active constraint set and evaluation function J, and finds a solution y of the simultaneous linear equation.

Computing device 1 performs an updating process (S3). The updating process corresponds to the process performed by updating unit 23 in FIG. 2. By performing the updating process, computing device 1 updates the active constraint set and the solution based on solution y obtained by the process of S2, and outputs the active constraint set and the optimal solution.

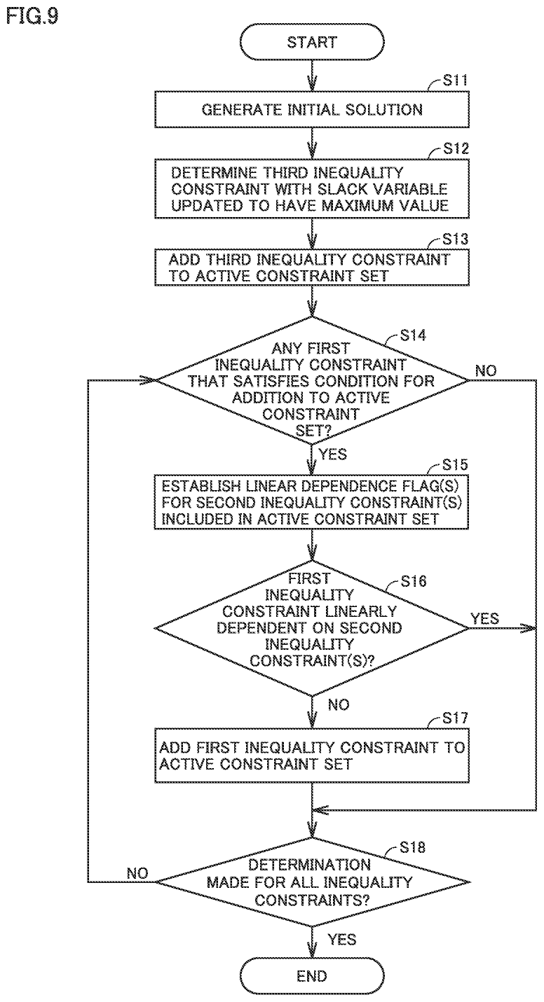

FIG. 9 is a flowchart showing the generation process of computing device 1 according to the embodiment. Each process shown in FIG. 9 is included in the generation process (S1) of FIG. 8. It should be noted that in FIG. 9, the process of S11 corresponds to the process performed by initial solution generation unit 111 in FIG. 4. The process in each of S12 and S13 corresponds to the process performed by maximum constraint addition unit 112 in FIG. 4. The process in S14 corresponds to the process performed by addition determination unit 113 in FIG. 4. The process in each of S15 and S16 corresponds to the process performed by linear dependence determination unit 114 in FIG. 4. The process in S17 corresponds to the process performed by active constraint addition unit 115 in FIG. 4.

As shown in FIG. 9, computing device 1 generates a feasible initial solution w₀ in accordance with whether or not initial solution worn satisfies the inequality constraint set represented by the formula (9) (S11). On this occasion, when initial solution worn does not satisfy the inequality constraint set, computing device 1 updates slack variable sₙ to have a larger value in the formula (10), thereby generating a feasible initial solution w₀ that satisfies the inequality constraint set of the formula (9).

Computing device 1 determines, as the third inequality constraint that is deviated the most from the constraint value, the inequality constraint updated to have the maximum slack variable value and included in the inequality constraint set (S12).

Computing device 1 adds the determined third inequality constraint to the active constraint set in precedence over other inequality constraint (S13). Thus, computing device 1 can add the third inequality constraint that is deviated the most from the constraint value, to the active constraint set in precedence over the inequality constraints added to the active constraint set after the processes of S14 to S17 described below.

For the other inequality constraints than the third inequality constraint, computing device 1 performs the processes of S14 to S17 in order of the one or more constraint numbers.

Computing device 1 determines whether or not the inequality constraint set includes a first inequality constraint that satisfies a condition for addition to the active constraint set (S14). When the inequality constraint set has no first inequality constraint that satisfies the condition for addition to the active constraint set (NO in S14), computing device 1 proceeds to the process of S18.

When the inequality constraint set includes a first inequality constraint that satisfies the condition for addition to the active constraint set (YES in S14), in order of one or more constraint numbers of one or more second inequality constraints included in the active constraint set, computing device 1 establishes one or more linear dependence flags for one or more elements which have non-zero coefficients and for which no linear dependence flags have been established (S15).

As described with reference to FIGS. 5 to 7, computing device 1 determines, based on the one or more linear dependence flags, whether or not the first inequality constraint that satisfies the condition for addition to the active constraint set is linearly dependent on the one or more second inequality constraints that are set as the current active constraints (S16). When the first inequality constraint is linearly dependent on the one or more second inequality constraints (YES in S16), computing device 1 skips the process of S17 and proceeds to the process of S18.

When the first inequality constraint is linearly dependent on the one or more second inequality constraints, i.e., when the first inequality constraint is linearly independent from the one or more second inequality constraints (NO in S16), computing device 1 adds, to the active constraint set, the first inequality constraint determined as being not linearly dependent on the one or more second inequality constraints (S17).

Computing device 1 determines whether or not determination for addition to the active constraint set has been made for all the inequality constraints included in the inequality constraint set (S18). When the determination for addition to the active constraint set has not been performed for all the inequality constraints (NO in S18), computing device 1 returns to the process of S14.

When the determination for addition to the active constraint has been performed for all the inequality constraints (YES in S18), computing device 1 ends the generation process.

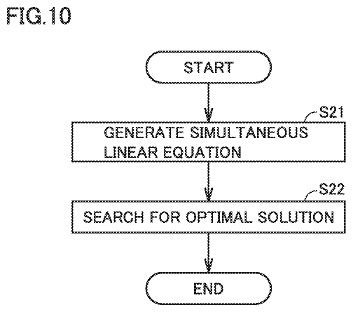

FIG. 10 is a flowchart showing the search process of computing device 1 according to the embodiment. Each process shown in FIG. 10 is included in the search process (S2) of FIG. 8.

Computing device 1 generates a simultaneous linear equation for finding the optimal solution of the convex quadratic programming problem, based on the active constraint set generated by the generation process and evaluation function J (S21). Computing device 1 generates a simultaneous linear equation for solving the minimization problem of evaluation function J having only active constraints as constraints. The minimization problem of evaluation function J having only the active constraints as constraints is represented by the following formulas (12) and (13):

$${min}_{w} J = \frac{1}{2} {w}^{T} Hw + {h}^{T} w \qquad ( 12 )$$

$$s . t . {A}_{k}^{T} w = {b}_{k} \qquad ( 13 )$$

Computing device 1 generates a simultaneous linear equation including a KKT condition (Karush-Kuhn-Tucker Condition) as indicated in the following formula (14):

$$[ \begin{matrix}H & {A}_{k} \\ {A}_{k}^{T} & O\end{matrix} ] [ \begin{matrix}y \\ λ\end{matrix} ] = [ \begin{matrix}- h \\ {b}_{k}\end{matrix} ] \qquad ( 14 )$$

In the formula (14), the subscript “k” corresponds to the number of iterations of computation of computing device 1. When interface 11 obtains the optimization problem and then search unit 22 performs the computation for the first time using the condition computed by generation unit 21, k=0. The subscript of feasible initial solution w₀ represents k=0. That is, the subscript “k” of solution wₖ corresponds to the number of iterations of computation by computing device 1. y represents a solution of the minimization problem when the number of iterations of computation as represented by the formulas (12) and (13) is k. λ represents a Lagrange multiplier corresponding to each constraint.

Computing device 1 finds solution y of the formula (14) using a numerical analysis method (S22). As the method for finding the solution of the simultaneous linear equation, the following methods have been known: a direct analysis method such as the Gaussian elimination method; and a method employing an iterative method such as a CG method (conjugate gradient method) or a GMRES method (Generalized Minimal RESidual method). It should be noted that before performing each of these numerical analysis methods, computing device 1 may perform a pre-process onto the simultaneous linear equation in order to increase numerical convergence and stability. Thereafter, computing device 1 ends the search process.

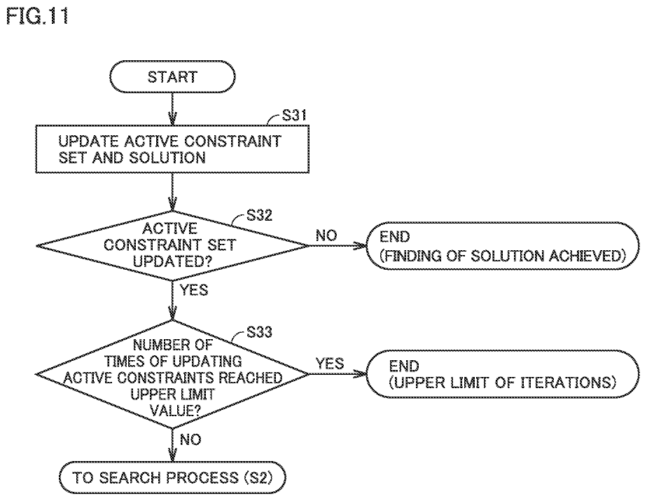

FIG. 11 is a flowchart showing the updating process of computing device 1 according to the embodiment. Each process shown in FIG. 11 is included in the updating process (S3) of FIG. 8.

Computing device 1 updates the active constraint set and the solution based on solution y obtained by the search process (S31). Computing device 1 determines a constraint to be added to or to be removed from the active constraint set in the following manner so as to update solution wₖ.

When there is a constraint to be added to the active constraint set, computing device 1 determines the active constraint set and solution wₖ₊₁ in the following manner. Specifically, when solution y obtained by the search process does not satisfy one or more of the constraints of the inequality constraint set represented by the formula (9), computing device 1 determines solution wₖ₊₁ using the following formula (15):

wₖ₊₁=(1−α)wₖ+αy (15)

In the formula (15), α is set to the maximum value under conditions that 0<α<1 and solution wₖ₊₁ satisfies the inequality constraint set. Further, computing device 1 generates an updated active constraint set by newly adding, to the active constraint set, a constraint that satisfies the equality constraint with respect to solution wₖ₊₁.

On the other hand, when there is a constraint to be removed in the active constraint set, computing device 1 determines the active constraint set and solution wₖ₊₁ in the following manner. Specifically, when solution y obtained by the search process satisfies all the constraints of the inequality constraint set represented by the formula (9), computing device 1 determines solution wₖ₊₁ using the following formula (16):

wₖ₊₁=y (16)

When solution y obtained by search unit 22 has values that satisfy Lagrange multiplier λ<0, computing device 1 removes, from the active constraint set, a constraint corresponding to the maximum absolute value among the values of solution y, thereby generating an updated active constraint set.

Computing device 1 determines whether or not the active constraint set has been updated (S32). Specifically, when no inequality constraint is added to the active constraint set and no inequality constraint is removed from the active constraint set (NO in S32), computing device 1 outputs solution wₖ₊₁ as the optimal solution and ends the computation.

When the active constraint set is updated (YES in S32), computing device 1 determines whether or not the number of times of updating the active constraints has reached an upper limit value set in advance (S33).

When the number of times of updating the active constraints has reached the upper limit value (YES in S33), computing device 1 ends the computation. When the number of times of updating the active constraints has not reached the upper limit value (NO in S33), computing device 1 performs the search process of S2 again using the updated active constraint set and solution wₖ₊₁.

Thus, computing device 1 according to the embodiment causes search unit 22 to search for a solution that minimizes evaluation function J under the constraint condition for the active constraint generated by generation unit 21. Computing device 1 causes updating unit 23 to update the active constraint set in accordance with the obtained solution, and repeats the process of search unit 22 searching for the solution that minimizes the evaluation function under the constraint condition for the updated active constraint. Computing device 1 finds an optimal solution that minimizes evaluation function J while satisfying all the inequality constraints represented by the formula (9).

In a conventional computing device for finding an optimal solution of a convex quadratic programming problem, when a plurality of inequality constraints that are set as active constraints are not in a linearly independent relation, the dimensions of a simultaneous linear equation including a condition to be satisfied by the optimal solution are decreased, with the result that the optimal solution cannot be found, disadvantageously.

On the other hand, even in the case where addition determination unit 113 determines that there is a first inequality constraint that satisfies a condition for addition to the active constraint set, computing device 1 according to the embodiment does not cause active constraint addition unit 115 to add the first inequality constraint to the active constraint set when linear dependence determination unit 114 determines that the first inequality constraint is linearly dependent on the one or more second inequality constraints included in the active constraint set. Thus, computing device 1 can maintain, in a linearly independent relation, the plurality of inequality constraints that are set as active constraints, and can solve such a problem that the optimal solution cannot be obtained by search unit 22. Thereafter, computing device 1 causes updating unit 23 to update the active constraint set; however, in the method for determining the inequality constraint to be added to the active constraint set, no inequality constraint to be linearly dependent on an inequality constraint that is set as an active constraint is theoretically added. As a result, computing device 1 can find the optimal solution of the convex quadratic programming problem.

Further, when inequality constraints linearly dependent on inequality constraints that are set as active constraints exist in the inequality constraint set input to computing device 1 and the inequality constraints are to be added to the active constraint set, computing device 1 does not find the optimal solution unless only a constraint that is the physically strictest among the inequality constraints to be added are added to the active constraint set.

Regarding this point, computing device 1 causes maximum constraint addition unit 112 to add the third inequality constraint, which is deviated the most from the constraint value at each prediction time, to the active constraint set in precedence over other inequality constraint. Further, computing device 1 causes linear dependence determination unit 114 to determine whether or not the first inequality constraint determined by addition determination unit 113 as satisfying the condition that allows the first inequality constraint to be an active constraint is linearly dependent on the active constraint including the third inequality constraint that is deviated the most from the constraint value, and does not add, to the active constraint set, the first inequality constraint that is linearly dependent on the active constraint. That is, after adding, to the active constraint set, the third inequality constraint that is deviated the most from the constraint value, computing device 1 does not add, to the active constraint set, the first inequality constraint that is linearly dependent on the third inequality constraint among the first inequality constraints determined as satisfying the condition that allows each the first inequality constraint to be an active constraint. Thus, computing device 1 can add only the physically strictest inequality constraint to the active constraint set.

As described above, the present disclosure is directed to a computing device 1 for finding an optimal solution of a convex quadratic programming problem. Computing device 1 comprises: an interface 11 to obtain an evaluation function J, an inequality constraint set, and an initial solution w₀ᵢₙ of the convex quadratic plan problem; and a processor 12 to find the optimal solution based on evaluation function J, the inequality constraint set, and initial solution w₀ᵢₙ obtained by interface 11. Processor 12 includes a generation unit 21, a search unit 22, and an updating unit 23. Generation unit 21 generates an active constraint set based on the inequality constraint set and initial solution w₀ᵢₙ. Search unit 22 finds a solution of a simultaneous linear equation generated based on the active constraint set and evaluation function J. Updating unit 23 updates the active constraint set based on the solution obtained by search unit 22. Generation unit 21 comprises an addition determination unit 113, a linear dependence determination unit 114, and an active constraint addition unit 115. Addition determination unit 113 determines whether or not the inequality constraint set includes a first inequality constraint that satisfies a condition for addition to the active constraint set. Linear dependence determination unit 114 determines whether or not the first inequality constraint that satisfies the condition is linearly dependent on one or more second inequality constraints included in the active constraint set. Active constraint addition unit 115 adds, to the active constraint set, the first inequality constraint determined by linear dependence determination unit 114 as being not linearly dependent on the one or more second inequality constraints.

According to such a configuration, computing device 1 can maintain, in a linearly independent relation, the one or more second inequality constraints that are set as the active constraints, with the result that the optimal solution of the convex quadratic programming problem can be found while avoiding a large computation load as much as possible.

Preferably, linear dependence determination unit 114 determines that the first inequality constraint is linearly dependent on the one or more second inequality constraints, when one or more elements included in the one or more second inequality constraints and having non-zero coefficients are a subset of one or more elements included in the first inequality constraint and having non-zero coefficients and when the number of the one or more elements included in each of the one or more second inequality constraints and having the non-zero coefficients is more than or equal to the number of the one or more elements included in the first inequality constraint and having the non-zero coefficients.

According to such a configuration, computing device 1 can determine whether or not the first inequality constraint is linearly dependent on the one or more second inequality constraints, by only determining whether or not the coefficient of a relevant inequality constraint is 0 by utilizing such a feature that a non-zero element exists only in an element corresponding to a control variable prior to a prediction time corresponding to each inequality constraint in the inequality constraints obtained by the model predictive control. Thus, in computing device 1, a computation load can be suppressed as compared with a determination method employing general numeric computation.

Preferably, in order of one or more constraint numbers of the one or more second inequality constraints, linear dependence determination unit 114 establishes one or more linear dependence flags for one or more elements which have non-zero coefficients and for which no linear dependence flags have been established, and linear dependence determination unit 114 determines that the first inequality constraint is linearly dependent on the one or more second inequality constraints, when the one or more linear dependence flags are established for all of the one or more elements included in the first inequality constraint and having the non-zero coefficients.

According to such a configuration, by using the linear dependence flags, computing device 1 can determine whether or not the first inequality constraint is linearly dependent on the one or more second inequality constraints. Further, computing device 1 can generate a linear dependence flag in accordance with only whether or not the coefficient of a relevant inequality constraint is 0. Thus, in computing device 1, a computation load can be suppressed as compared with a determination method employing general numeric computation.

Preferably, in initial solution w₀ᵢₙ, generation unit 21 adds a third inequality constraint to the active constraint set in precedence over other inequality constraint, the third inequality constraint being a constraint that is included in the inequality constraint set and that is deviated the most from a constraint value at each prediction time.

According to such a configuration, computing device 1 can add only the physically strictest inequality constraint of the inequality constraint set to the active constraint set. Further, after adding, to the active constraint set, the third inequality constraint that is deviated the most from the constraint value, computing device 1 does not add, to the active constraint set, a first inequality constraint that is linearly dependent on the third inequality constraint among first inequality constraints determined as satisfying the condition that allows each first inequality constraint to be an active constraint, with the result that only the physically strictest inequality constraint can be added to the active constraint set. Thus, computing device 1 can appropriately find the optimal solution of the convex quadratic programming problem.

The present disclosure is directed to a method for finding an optimal solution of a convex quadratic programming problem by a computer (processor 12). The computing method includes: (S1) generating an active constraint set based on an inequality constraint set and an initial solution w₀ᵢₙ in the convex quadratic programming problem; (S2) finding a solution of a simultaneous linear equation generated based on the active constraint set and an evaluation function J in the convex quadratic programming problem; and (S3) updating the active constraint set based on the solution obtained by the finding (S2) of the solution. The generating (S1) comprises: (S14) determining whether or not the inequality constraint set includes a first inequality constraint that satisfies a condition for addition to the active constraint set; (S16) determining whether or not the first inequality constraint that satisfies the condition is linearly dependent on one or more second inequality constraints included in the active constraint set; and (S17) adding, to the active constraint set, the first inequality constraint determined, by the determining (S16) of whether or not the first inequality constraint that satisfies the condition is linearly dependent on the one or more second inequality constraints included in the active constraint set, as being not linearly dependent on the one or more second inequality constraints.

According to such a method, processor 12 (computer) of computing device 1 can maintain, in a linearly independent relation, the one or more second inequality constraints that are set as the active constraints, with the result that the optimal solution of the convex quadratic programming problem can be found while avoiding a large computation load as much as possible.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A computing device for finding an optimal solution of a convex quadratic programming problem, the computing device comprising:
an interface to obtain an evaluation function, an inequality constraint set, and an initial solution of the convex quadratic programming problem; and
a processor to find the optimal solution based on the evaluation function, the inequality constraint set, and the initial solution obtained by the interface, wherein
the processor comprises
a generation unit to generate an active constraint set based on the inequality constraint set and the initial solution,
a search unit to find a solution of a simultaneous linear equation generated based on the active constraint set and the evaluation function, and
an updating unit to update the active constraint set based on the solution obtained by the search unit,
the generation unit comprises
an addition determination unit to determine whether or not the inequality constraint set includes a first inequality constraint that satisfies a condition for addition to the active constraint set,
a linear dependence determination unit to determine whether or not the first inequality constraint that satisfies the condition is linearly dependent on one or more second inequality constraints included in the active constraint set, and
an active constraint addition unit to add, to the active constraint set, the first inequality constraint determined by the linear dependence determination unit as being not linearly dependent on the one or more second inequality constraints.

2. The computing device according to claim 1, wherein the linear dependence determination unit determines that the first inequality constraint is linearly dependent on the one or more second inequality constraints, when one or more elements included in each of the one or more second inequality constraints and having non-zero coefficients are a subset of one or more elements included in the first inequality constraint and having non-zero coefficients and when the number of the one or more elements included in the one or more second inequality constraints and having the non-zero coefficients is more than or equal to the number of the one or more elements included in the first inequality constraint and having the non-zero coefficients.

3. The computing device according to claim 1, wherein
in order of one or more constraint numbers of the one or more second inequality constraints, the linear dependence determination unit establishes one or more linear dependence flags for one or more elements which have non-zero coefficients and for which no linear dependence flags have been established, and
the linear dependence determination unit determines that the first inequality constraint is linearly dependent on the one or more second inequality constraints, when the one or more linear dependence flags are established for all of the one or more elements included in the first inequality constraint and having the non-zero coefficients.

4. The computing device according to claim 1, wherein in the initial solution, the generation unit adds a third inequality constraint to the active constraint set in precedence over other inequality constraint, the third inequality constraint being a constraint that is included in the inequality constraint set and that is deviated the most from a constraint value at each prediction time.

5. A computing method for finding an optimal solution of a convex quadratic programming problem by a computer, the computing method comprising:
generating an active constraint set based on an inequality constraint set and an initial solution in the convex quadratic programming problem;
finding a solution of a simultaneous linear equation generated based on the active constraint set and an evaluation function in the convex quadratic programming problem; and
updating the active constraint set based on the solution obtained by the finding of the solution, wherein
the generating comprises
determining whether or not the inequality constraint set includes a first inequality constraint that satisfies a condition for addition to the active constraint set,
determining whether or not the first inequality constraint that satisfies the condition is linearly dependent on one or more second inequality constraints included in the active constraint set, and
adding, to the active constraint set, the first inequality constraint determined, by the determining of whether or not the first inequality constraint that satisfies the condition is linearly dependent on the one or more second inequality constraints included in the active constraint set, as being not linearly dependent on the one or more second inequality constraints.
